(19) United States
(12) Patent Application Publication
(10) Pub. No.: US 2004/0182311 A1
(43) Pub. Date: Sep. 23, 2004

(54) Semiconductor processing apparatus having semiconductor wafer mounting

(75) Inventor: Minoru Hanazaki, Hyogo (JP)

Correspondence Address: McDermott, Will & Emery, 600 13th Street, N.W., Washington, DC, 20005-3096, US

(73) Assignee: RENESAS TECHNOLOGY CORP.

(21) Appl. No.: 10/800,710

(22) Filed: Mar. 16, 2004

(30) Foreign Application Priority Data
Mar. 17, 2003 (JP) 2003-072227 (P)

(51) Int. Cl. B05C 11/00

(52) U.S. Cl. 118/663

(57) ABSTRACT

A semiconductor processing apparatus detecting sticking of a wafer includes a stage on which a wafer is mounted, a wafer lift pin for separating the wafer from the stage, a control device controlling a vibrator power supply and control unit to vibrate a vibrator, controlling a detector to detect a state of vibration, and detecting presence/absence of sticking between the wafer and the stage based on the state of vibration prior to raising of the wafer with the wafer lift pin, and an alarm device outputting an alarm when the sticking occurs.

### BACKGROUND OF THE INVENTION

1. Field of the Invention

The present invention relates to an apparatus for processing semiconductor wafers, and more particularly to an apparatus capable of detecting and preventing a defect that would occur when a semiconductor wafer having undergone desired processing is removed from a wafer mounting table.

2. Description of the Background Art

Conventionally, an IC (Integrated Circuit) chip having a circuit of which wiring pattern is changed according to the specification requested by a customer has been produced. The manufacturing process of such an IC chip includes a wafer process in which a wafer is repeatedly subjected to etching, thin-film deposition and other processing, using a mask having a shielding pattern formed of a metal thin film on a quart substrate as a master.

In the wafer process, the wafer is mounted on a wafer mounting table (stage) in a processing room where desired processing is carried out. After the desired processing is completed, a wafer lift pin protruding from inside the stage onto an upper surface thereof is activated to raise the wafer with the wafer lift pin, so that the wafer is separated from the stage. A transfer system then transfers the wafer separated from the stage to the outside of the processing room.

At this time, however, the wafer may be stuck to the stage (which is referred to as “sticking”) due to static electricity or the like. If the wafer lift pin is activated while such sticking occurs, the wafer may crack, or slip off the stage, which may cause displacement of the wafer leading to failure of wafer transfer. If such a wafer crack or failure of wafer transfer occurs, the wafer processing apparatus should be temporarily stopped to recover the wafer, causing degradation in operating rate of the apparatus. Particularly, in an apparatus where desired processing such as etching, ion implanting, sputtering or the like is performed in a vacuum, it is necessary to let the pressure inside the apparatus equal to the atmospheric pressure to recover the wafer, and then back to the vacuum. Various apparatuses have been developed to overcome the sticking problem.

Japanese Patent Laying-Open No. 11-162392 discloses an ion implantation apparatus capable of detecting sticking. The ion implantation apparatus includes: a processing stand arranged in a vacuum chamber and holding a plurality of wafers, the vacuum chamber having an outer wall that is at least partially transparent; a wafer holder having a chuck plate for chucking the wafers to allow mounting and dismounting of the wafers to and from the processing stand; a laser displacement sensor measuring a distance from the transparent outer wall to the chuck plate when taking out the wafer having undergone the ion implantation from the processing stand using the chuck plate; and a determination circuit determining that there is sticking when the measured distance exceeds a predetermined threshold value.

With this ion implantation apparatus, presence/absence of sticking is automatically detected, so that wafer transfer is stopped when the sticking is detected to avoid any troubles attributed to the occurrence of sticking. As such, the wafer transfer in the ion implantation apparatus can be done without troubles and reliability thereof is increased.

Japanese Patent Laying-Open No. 11-260894 discloses a semiconductor manufacturing apparatus capable of preventing a trouble in transportation of wafers such as wafer cracking when the wafer is attracted to the stage by charges. This semiconductor manufacturing apparatus has a wafer stage and a lift jig for lifting the wafer mounted on the wafer stage. A tip end of the lift jig that comes into contact with the wafer is formed of a conductive material.

With this semiconductor manufacturing apparatus, when the wafer is attracted to the stage by charges, the charges on the wafer are released via the conductive material that is grounded, so that trouble in transfer is avoided. As such, it is possible to suppress attraction of the wafer due to charges, and prevent transfer trouble due to displacement of the wafer.

Japanese Patent Laying-Open No. 11-330217 discloses a substrate separating method with which a substrate is smoothly separated from an electrostatic chuck plate. This substrate separating method includes the step of arranging a substrate on a double-pole type electrostatic chuck plate having a pair of electrodes arranged in a dielectric, the step of applying positive and negative voltages to the pair of electrodes to process the substrate in an electrostatically attracted state in a vacuum, the step of calculating, based on a relation between an applied amount of a reverse voltage and an amount of residual charges after application thereof that is obtained in advance for each of the electrodes depending on the kind of the substrate and the content of the processing, an application amount of the reverse voltage with which absolute values of the amounts of residual charges of the respective electrodes become approximately equal to each other, the step of applying to the substrate the reverse voltage of an opposite polarity to that of the voltage applied at the time of electrostatic attraction by the calculated amount to reduce the residual charges, and the step of separating the substrate from the double-pole type chuck plate.

With this substrate separating method, the relation between the applied amount of the reverse voltage and the amount of charges remaining after application thereof is obtained in advance for each electrode, and based on the relation, the application amount of the reverser voltage that makes the amounts of residual charges in the electrodes approximately equal to each other is calculated. The reverse voltage of the calculated amount is applied after the vacuum processing is performed. This not only reduces the amounts of residual charges themselves, but also equalizes the forces of attraction of the residual charges on the positive and negative electrodes. As such, the substrate is attracted uniformly, and thus, it can be separated smoothly. As a result, uneven electrostatic attraction by the residual charges is eliminated, and bounce or falling of the substrate is prevented.

Japanese Patent Laying-Open No. 9-27541 discloses a substrate holder capable of preventing displacement of a substrate when it is lifted by releasing suction and also preventing the substrate from being damaged or electrified by being lifted before the suction is not fully released. The substrate holder has a mounting surface on which the substrate is mounted. The substrate is sucked and secured to the mounting surface by evacuation with a suction device via a tube member in communication with the mounting surface. The substrate holder includes: a gas supplying unit which supplies a gas to the tube member to release the suction; a substrate supporting unit which has a support unit movable upward and downward on the mounting surface, and which supports the substrate on the support unit when the support unit comes above the mounting surface, to let the substrate removed from the mounting surface; a driving unit which drives the substrate supporting unit; a force detecting unit which detects a force against the driving force of the driving unit; and a control unit which controls the gas supplying unit to supply the gas when the force detected by the force detecting unit becomes a prescribed value.

With this substrate holder, the force detecting unit detects the force applied to the driving unit by means of an ammeter which detects a change of a current flowing through the driving unit. When the force becomes a prescribed value, the control unit controls to supply a gas to the mounting surface. This prevents application of unnecessarily high load to the substrate. Accordingly, it is possible to lift the substrate from the mounting surface without forcibly peeling the substrate sucked to the mounting surface, which would otherwise cause break or electrification of the substrate.

In the ion implantation apparatus disclosed in Japanese Patent Laying-Open No. 11-162392, however, occurrence of sticking is determined only after the chuck plate is bent or flexed to a degree that can be detected by the laser displacement sensor. In other words, when it is determined that sticking has occurred, the chuck plate is already flexed, in which case force may have already been applied to claws gripping the wafer, possibly cracking or damaging the wafer. Even if there is no visible damage, strain may remain on the wafer, and the wafer may well be broken during the subsequent heat treatment or the like.

Further, the semiconductor manufacturing apparatus disclosed in Japanese Patent Laying-Open No. 11-260894 and the substrate separating method disclosed in Japanese Patent Laying-Open No. 11-330217 are effective only when sticking is attributed to static electricity. In addition, in the semiconductor manufacturing apparatus of Japanese Patent Laying-Open No. 11-260894, the amount of charges (residual charges) remaining at the wafer is unknown. Thus, there is a possibility that the wafer lift pin may be operated while the wafer is still attracted to the stage with the charges still remaining, which may cause break of the wafer or displacement of the separated wafer.

Still further, in any of the ion implantation apparatus disclosed in Japanese Patent Laying-Open No. 11-162392, the semiconductor manufacturing apparatus disclosed in Japanese Patent Laying-Open No. 11-260894, and the substrate holder disclosed in Japanese Patent Laying-Open No. 9-27541, occurrence of sticking cannot be detected before start of an operation of the wafer lift pin, the chuck plate or the support unit. In other words, the occurrence of sticking is detected only after a trouble possibly causing wafer cracking occurs, or after the apparatus is stopped due to the wafer cracking, failure of wafer transfer or the like. As such, possibility of wafer cracking or stoppage of the apparatus cannot be prevented.

### SUMMARY OF THE INVENTION

An object of the present invention is to provide a semiconductor processing apparatus capable of detecting occurrence of sticking of a wafer before actually coming into contact with the wafer.

Another object of the present invention is to provide a semiconductor processing apparatus capable of detecting occurrence of sticking of a wafer before actually coming into contact with the wafer, to suppress a possibility of wafer cracking and prevent displacement of a separated position of the wafer.

Yet another object of the present invention is to provide a semiconductor processing apparatus capable of canceling sticking of a wafer when occurrence of the sticking is detected before actually coming into contact with the wafer, to thereby suppress a possibility of wafer cracking and prevent displacement of a separated position of the wafer.

A semiconductor processing apparatus according to the present invention includes a vibration applying unit attached to a wafer mounting electrode and applying vibration to a wafer mounted on the electrode, a vibration detecting unit attached to the wafer mounting electrode and detecting vibration induced at the wafer mounted on the electrode, and a determining unit determining presence/absence of sticking of the wafer based on the vibration detected by the vibration detecting unit.

Preferably, the semiconductor processing apparatus may further include an output unit that outputs an alarm when the determining unit determines that the sticking is present.

Still preferably, the semiconductor processing apparatus may further include a stop unit that stops the semiconductor processing when the determining unit determines that the sticking is present.

Still preferably, the semiconductor processing apparatus may further include a communication unit that sends sticking information to a host computer when the determining unit determines that the sticking is present.

Still preferably, the semiconductor processing apparatus may further include a processing unit that cancels sticking when the determining unit determines that the sticking is present.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of a semiconductor processing apparatus according to a first embodiment of the present invention.

FIGS. 2A-2C each show a relation between frequency and signal intensity detected by a detector of the semiconductor processing apparatus of the first embodiment.

FIG. 3 is a flowchart illustrating a process carried out by a control device of the semiconductor processing apparatus according to the first embodiment.

FIG. 4 is a flowchart illustrating error processing carried out by the control device of the semiconductor processing apparatus of the first embodiment.

FIG. 5 shows a configuration of a semiconductor processing apparatus according to a first modification of the first embodiment of the present invention.

FIG. 6 is a flowchart illustrating sticking cancellation processing carried out by a control device of the semiconductor processing apparatus according to the first modification of the first embodiment.

FIG. 7 shows a configuration of a semiconductor processing apparatus according to a second modification of the first embodiment of the present invention.

FIG. 8 is a flowchart illustrating the sticking cancellation processing carried out by a control device of the semiconductor processing apparatus according to the second modification of the first embodiment.

FIG. 9 shows a configuration of a semiconductor processing apparatus according to a second embodiment of the present invention.

FIGS. 10A-10C each show a relation between frequency and signal intensity detected by a detector of the semiconductor processing apparatus of the second embodiment.

FIG. 11 is a flowchart illustrating a process carried out by a control device of the semiconductor processing apparatus according to the second embodiment.

FIG. 12 shows a configuration of a vibrator also serving as a detector of a semiconductor processing apparatus according to a third embodiment of the present invention.

FIGS. 13A and 13B show waveforms of vibration output from the vibrator shown in FIG. 12.

### DESCRIPTION OF THE PREFERRED EMBODIMENTS

Hereinafter, embodiments of the present invention will be described with reference to the drawings. In the following description and throughout the drawings, the same reference characters denote the same portions with the same names and functions. Thus, detailed description thereof will not be repeated where appropriate.

First Embodiment

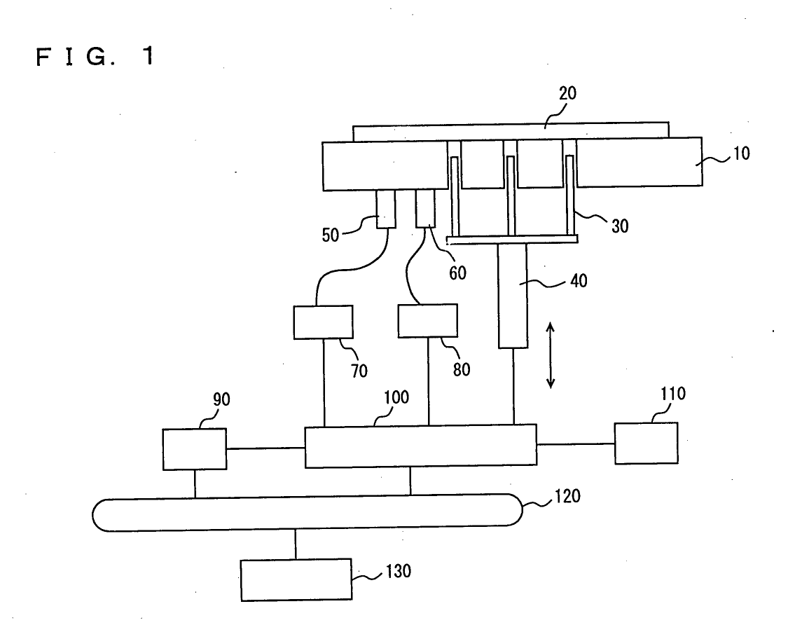

A configuration of the semiconductor processing apparatus according to a first embodiment of the present invention is described with reference to FIG. 1. FIG. 1 is a cross sectional view of a portion of the semiconductor processing apparatus, specifically showing a stage 10 for mounting a wafer 20 thereon and its surroundings.

The semiconductor processing apparatus includes the stage 10 on which the wafer 20 is mounted, a wafer lift pin 30 for separating wafer 20 having undergone processing in the semiconductor processing apparatus from stage 10, and a cylinder 40 for moving wafer lift pin 30 upward and downward. The semiconductor processing apparatus further includes a vibrator 50 for applying vibration to wafer 20 mounted on stage 10, a vibrator power supply and control unit 70, a detector 60 detecting a state of vibration of wafer 20, a detector power supply and control unit 80, and a control device 100 controlling the entire apparatus.

Control device 100 is connected with vibrator power supply and control unit 70, detector power supply and control unit 80, and cylinder 40. An alarm device 110 is also connected to control device 100. A transfer device controller 90 and a network 120 are also connected to control device 100. A host computer 130 is connected via network 120 to control device 100 in a communicable manner.

A wafer transfer device (controlled by transfer device controller 90) transfers wafer 20 into a processing room of the semiconductor processing apparatus in which predetermined processing is carried out. Wafer 20 is received by wafer lift pin 30 that is movable upward and downward and protrudes from within stage 10 to a surface thereof. The wafer transfer device then exits the processing room, wafer lift pin 30 is lowered, and wafer 20 is mounted on stage 10. Wafer 20 thus mounted at a prescribed position on stage 10 is subjected to predetermined processing for a semiconductor wafer. Thereafter, wafer 20 is separated from stage 10 by means of wafer lift pin 30 that moves upward and protrudes from within stage 10 to the surface thereof. Wafer 20 is then transferred to the outside of the processing room by the wafer transfer device.

In such a semiconductor processing apparatus, wafer 20 may be stuck to stage 10, which is called “sticking”. A detecting method of the sticking is now explained.

When a voltage of an arbitrary frequency fi (Hz) is applied from vibrator power supply and control unit 70 to vibrator 50 arranged beneath stage 10 at a time after completion of the predetermined processing in the semiconductor processing apparatus and before start of the operation of separating wafer 20 from stage 10 by means of wafer lift pin 30 moving upward and protruding from within stage 10 to its surface, vibrator 50 generates vibration of frequency fi (Hz), which vibration is applied to stage 10.

In the absence of sticking, wafer 20 is simply rested on stage 10. When wafer 20 receives the vibration from stage 10, if the frequency of vibrator 50 coincides with a natural frequency of wafer 20 (fr (Hz) in the present embodiment), sympathetic vibration occurs on wafer 20. The vibration of stage 10 may generate so-called “chatter” vibration, which is different from the sympathetic vibration, between stage 10 and wafer 20, depending on the frequency of vibrator 50 (fb (Hz) in the present embodiment).

When the sympathetic vibration occurs on wafer 20, detector 60 detects a signal that is at a frequency equal to frequency fr (Hz), which is the same as frequency fi (Hz) applied from vibrator 50, but its signal intensity is increased because of the sympathetic vibration. When the so-called “chatter” vibration occurs, the vibration is centered on another frequency fb (Hz) that is different from the frequency fi (Hz) applied from vibrator 50.

Detecting these vibrations with detector 60 attached to stage 10 and driven by detector power supply and control unit 80 makes it possible to detect presence/absence of sticking without the need of and hence before the operation of wafer lift pin 30.

When the sticking occurs with wafer 20 stuck to stage 10, stage 10 and wafer 20 become integrated, and thus, vibration at a natural frequency different from that of the case of wafer 20 alone is generated. The natural frequency of the integrated stage 10 and wafer 20 is lowered compared to the case of wafer 20 alone, and thus, it differs from natural frequency fr (Hz) of wafer 20 in the absence of sticking.

As such, the sympathetic vibration does not occur with the frequency fr (Hz). The so-called “chatter” vibration does not occur either, since stage 10 and wafer 20 are integrated. Thus, in the presence of sticking, a signal detected by detector 60 attached to stage 10 does not include sympathetic or “chatter” vibration. Rather, the detected signal has frequency fi (Hz) equal to frequency fi (Hz) applied from vibrator 50 and vibration intensity slightly decreased due to the loss within stage 10.

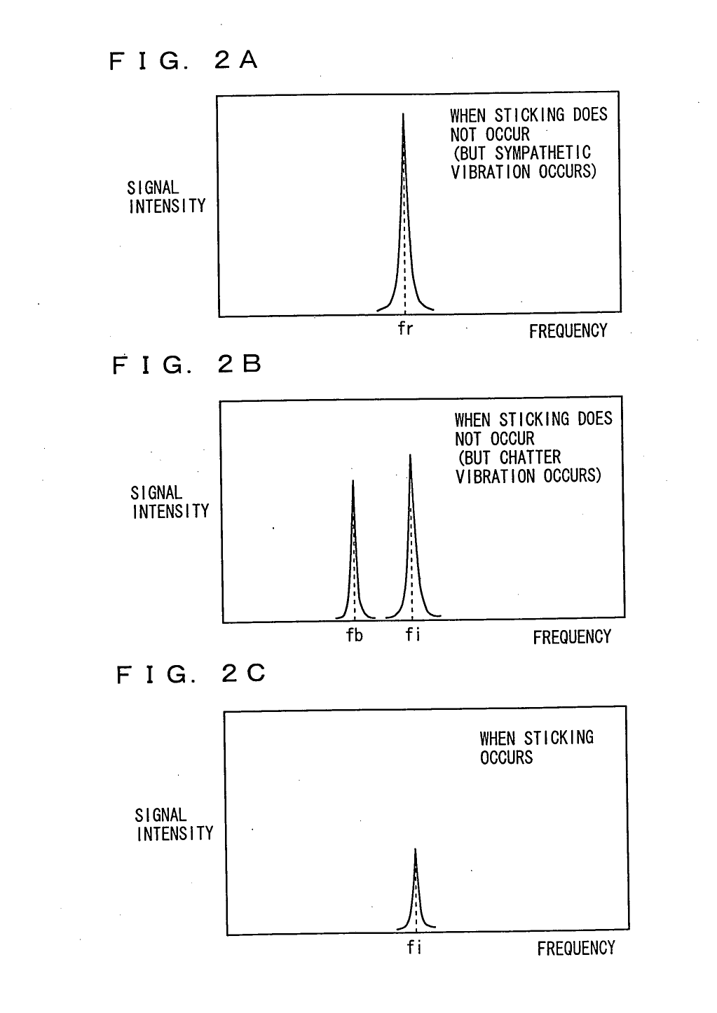

FIGS. 2A-2C each illustrate frequency distribution and signal intensity of vibration detected by detector 60 in the presence or absence of sticking, which is measured by a spectrum analyzer. FIGS. 2A, 2B and 2C are shown by way of example, and the magnitudes of frequencies fi (Hz), fr (Hz), fb (Hz), their frequency distribution curves, signal intensity distributions and threshold values are determined in accordance with dimensions, structures and materials of stage 10 in the semiconductor processing apparatus, of wafer 20, and of other structures in the vicinity of stage 10.

FIG. 2A shows the relation between frequency and signal intensity in the case where the sympathetic vibration occurs in the absence of sticking. In FIG. 2A, the frequency causing the peak of signal intensity is the frequency of sympathetic vibration, which coincides with the natural frequency of wafer 20.

FIG. 2B shows the relation between frequency and signal intensity in the case where the so-called “chatter” vibration occurs in the absence of sticking. As seen from FIG. 2B, when the “chatter” vibration occurs, vibration centered on another frequency fb (Hz) different from the frequency causing the peak of the signal intensity shown in FIG. 2A is generated.

FIG. 2C shows the relation between frequency and signal intensity in the presence of sticking. When the sticking occurs, stage 10 and wafer 20 are integrated, and thus, the sympathetic vibration does not occur with the frequency fr (Hz), nor does the “chatter” vibration, as shown in FIG. 2C. Instead, a signal having its vibration intensity slightly decreased due to the loss within stage 10 is detected at the frequency fi (Hz) equal to the frequency fi (Hz) applied from vibrator 50.

To improve precision in detection of the occurrence of sticking, it is desirable to measure, in advance in the absence of sticking, a frequency at which sympathetic vibration occurs on wafer 20. Further, the occurrence of sticking may be detected based on a difference in phase of vibration between the waveform of the vibration applied to wafer 20 by vibrator 50 and the waveform of the vibration detected by detector 60. Still further, the intensity, frequency and phase of vibration may be combined to detect the sticking. As such, the occurrence of sticking may be detected based on differences in various factors (including intensity, frequency and phase of vibration) attributed to the difference in waveform between the applied vibration and the detected vibration or the difference in waveform of the detected signals.

Vibrator 50 and detector 60 are each formed of piezoelectric ceramic utilizing the piezoelectric effect of barium titanate (BaTiO₃). When an alternating voltage is applied to the piezoelectric ceramic, the ceramic is strained at the applied frequency due to the inverse piezoelectric effect, and thus, vibration is generated. On the other hand, when the piezoelectric ceramic receives vibration, the ceramic is strained at the frequency, so that a voltage of the frequency is induced by the piezoelectric effect.

Although the use of barium titanate for vibrator 50 and detector 60 has been explained in the present embodiment, the material is not limited thereto, and may be any material as long as it has the piezoelectric and inverse piezoelectric effects. For example, the similar effects can be obtained by using piezoelectric ceramic having a crystal structure of perovskite type, such as lead zirconate titanate (Pb (Zr, Ti) 03), LiNbO₃, LiTaO₃, KNbO₃ or the like, piezoelectric macromolecule such as poly(vinylidene fluoride), or rock crystal. Alternatively, ceramic having a magnetostriction effect to which an alternating-current magnetic field, instead of the alternating voltage, is applied to generate vibration may be employed.

Further, instead of the piezoelectric element, vibrator 50 may employ a mechanical vibration generating method, such as a weight attached to a rotary shaft of a motor in an eccentric manner. Such mechanical vibration may also be generated by driving a magnetic material with a magnetic field generated by a magnet, coil or the like.

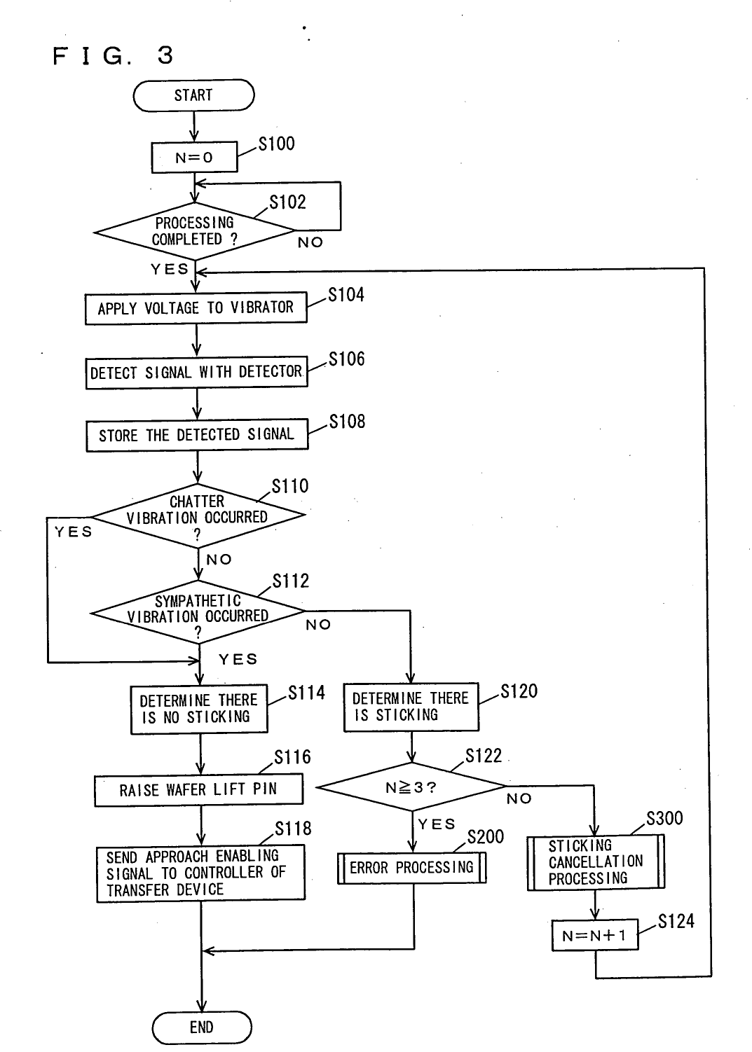

Hereinafter, a control structure of a program executed by control device 100 of the semiconductor processing apparatus according to the present embodiment is described with reference to FIG. 3.

In step (hereinafter, abbreviated as “S”) 100, control device 100 initializes a variable N (N=0). In S102, control device 100 determines whether predetermined processing has been completed in the semiconductor processing apparatus. If so (YES in S102), the process goes to S104. If not (NO in S102), the process returns to S102, and waits for completion of the predetermined processing.

In S104, control device 100 applies a voltage to vibrator 50. At this time, control device 100 sends a control signal designating start of application of the voltage to vibrator power supply and control unit 70, which in turn applies the voltage to vibrator 50. In S106, control device 100 detects a signal using detector 50 and detector power supply and control unit 80. The signal detected at this time is a signal representing vibration of stage 10 and wafer 20. In S108, control device 100 stores the detected signal.

In S110, control device 100 determines whether “chatter” vibration has occurred. When the “chatter” vibration occurs, the frequency and the signal intensity have the characteristics as shown in FIG. 2B. When it is determined that the “chatter” vibration has occurred (YES in S110), the process goes to S114. If not (NO in S110), the process goes to S112.

In S112, control device 100 determines whether sympathetic vibration has occurred. When the sympathetic vibration occurs, the relation between the frequency and the signal intensity is as shown in FIG. 2A. When it is determined that the sympathetic vibration has occurred (YES in S112), the process goes to S114. If not (NO in S112), the process goes to S120.

In S114, control device 100 determines that there is no sticking. In S116, control device 100 causes an operation to raise wafer lift pin 30 by cylinder 40. In S118, control device 100 sends an approach enabling signal to transfer device controller 90.

In S120, control device 100 determines that there is sticking. In S122, control device 100 determines whether variable N is greater than 3. If so (YES in S122), the process goes to S200. If not (NO in S122), the process goes to S300.

In S200, control device 100 performs error processing. The error processing in S200 will be described later in detail.

In S300, control device 100 performs sticking cancellation processing. The details of the sticking cancellation processing in S300 will be described later as a modification of the present embodiment.

In S124, control device 100 increments variable N by 1. Thereafter, the process returns to S104.

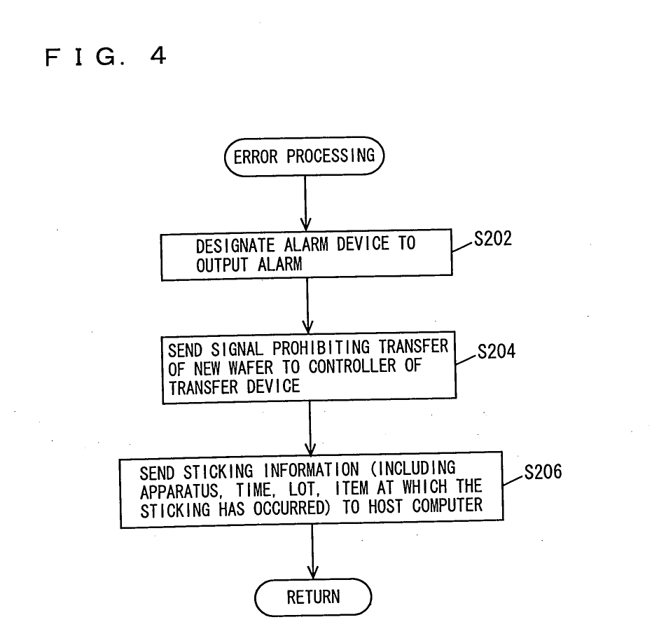

The error processing in S200 of FIG. 3 is now explained in detail with reference to FIG. 4.

In S202, control device 100 designates alarm device 110 to output an alarm. In S204, control device 100 sends a signal prohibiting transfer of a new wafer to transfer device controller 90. In S206, control device 100 sends sticking information to host computer 130. The sticking information may include information specifying the semiconductor processing apparatus in which the sticking has occurred, information specifying the time of occurrence of the sticking, information specifying the lot where the sticking has occurred, information specifying the item suffering the sticking, and others.

An operation of the semiconductor processing apparatus according to the present embodiment based on the above-described structure and flowchart is now described.

Wafer 20 is transferred by the wafer transfer device into the processing room where semiconductor processing is performed, and is received by wafer lift pin 30 that is movable up and down and protrudes from within stage 10 to a surface thereof. With wafer lift pin 30 retracted, wafer 20 is mounted on stage 10. When predetermined processing is completed in the semiconductor processing apparatus (YES in S102), control device 100 sends a control signal to vibrator power supply and control unit 70 to make it apply a voltage to vibrator 50 (S104). A signal is detected by detector 60 (S106) and is stored (S108). The signal stored at this time may be as shown in any of FIGS. 2A-2C.

When the “chatter” vibration occurs (YES in S110), it is determined that there is no sticking (S114). Even in the absence of the “chatter” vibration (NO in S110), when the sympathetic vibration occurs (YES in S112), it is again determined that there is no sticking (S114).

In the absence of both the “chatter” vibration (NO in S110) and the sympathetic vibration (NO in S112), it is determined that there is sticking (S120).

When it is determined that there is no sticking (S114), wafer lift pin 30 is raised using cylinder 40 (S116). An approach enabling signal is sent to transfer device controller 90 (S118), and the transfer device transfers wafer 20 separated from stage 10 by means of wafer lift pin 30 to the outside of the processing room.

When it is determined that there is sticking and variable N is 3 or smaller (NO in S122), sticking cancellation processing is carried out (S300). After the processing for canceling the sticking, variable N is incremented by 1 (S124). A voltage is applied again to the vibrator, a signal is detected again with the detector, and the presence/absence of sticking is determined again based on the detected signal.

If it is determined that there is still sticking even after the sticking cancellation processing is conducted three times (YES in S122), the error processing is performed (S200).

In the error processing, alarm device 110 is designated to output an alarm (S202), and the alarm information indicating occurrence of sticking is output from alarm device 110. Further, a signal prohibiting transfer of a new wafer is sent to transfer device controller 90 (S204), and transfer of new wafers to the semiconductor processing apparatus suffering the sticking is prevented. Further, sticking information is sent to host computer 130 (S206), which in turn analyzes the sticking based on the information indicating the apparatus, the time, the lot, and the item at which the sticking has occurred.

As described above, according to the semiconductor processing apparatus of the present embodiment, after prescribed semiconductor processing is completed and before an operation of separating the semiconductor wafer from the stage is actually performed, vibration is applied to the stage and its vibration is detected. The detected signal is used to determine whether sticking is occurring between the wafer and the stage, and if so, the sticking cancellation processing is carried out. If the sticking is not canceled even after such sticking cancellation processing is repeatedly performed, the error processing is carried out. Although the case where N=3 has been described in the above embodiment, N may be any number of at least 1.

As such, it is possible to provide a semiconductor processing apparatus capable of detecting occurrence of sticking of a wafer before actually contacting the wafer. Further, it is possible to provide a semiconductor processing apparatus capable of performing sticking cancellation processing when occurrence of sticking of a wafer is detected, to eliminate a possibility of wafer cracking and suppress displacement of a separated position of the wafer.

First Modification of First Embodiment

Hereinafter, a first modification of the semiconductor processing apparatus according to the first embodiment is described. The semiconductor processing apparatus according to the present modification further includes a structure for performing the sticking cancellation processing in S300 of FIG. 3.

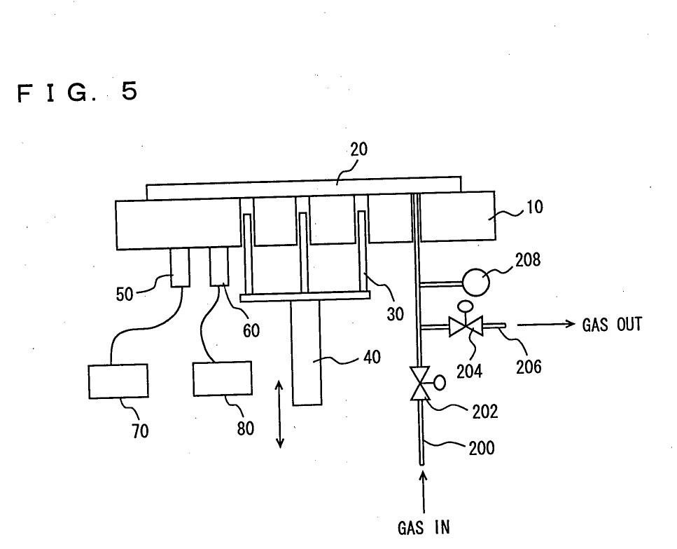

Referring to FIG. 5, a configuration of the semiconductor processing apparatus according to the present modification is described. In addition to the configuration of the semiconductor processing apparatus described above in conjunction with FIG. 1, the semiconductor processing apparatus of the present modification includes a heat transfer accelerating gas supply line 200 for supplying a gas for accelerating heat transfer, a heat transfer accelerating gas supply valve 202 provided between heat transfer accelerating gas supply line 200 and the interior of the processing room, a heat transfer accelerating gas exhaust line 206 for exhausting the heat transfer accelerating gas to the outside of the processing room, a heat transfer accelerating gas exhaust valve 204 provided at heat transfer accelerating gas exhaust line 206, and a pressure sensor 208 detecting a pressure of the heat transfer accelerating gas in the processing room.

Heat transfer accelerating gas supply valve 202, heat transfer accelerating gas exhaust valve 204 and pressures sensor 208 are connected to control device 100. Otherwise, the semiconductor processing apparatus of the present modification has the structure identical to that of the semiconductor processing apparatus of the first embodiment described above, and thus, detailed description thereof will not be repeated here.

Of the semiconductor processing apparatuses for processing wafers, particularly in the apparatuses employing plasma for the wafer process and the apparatuses required to accurately control the temperature during the wafer process, stage 10 in the processing room is supplied with a heat transfer accelerating gas for accelerating heat transfer between wafer 20 and stage 10. The gas may be a helium gas, for example, which is supplied at a prescribed pressure from a gas supply source via heat transfer accelerating gas supply line 200 and heat transfer accelerating gas supply valve 202 to stage 10. There may also be provided a wafer rise preventing mechanism, such as the one mechanically holding down the periphery of wafer 20, or the one holding wafer 20 with an electrostatic force, to prevent wafer 20 from moving or rising from stage 10 by a pressure of the helium gas or the like supplied between wafer 20 and stage 10 at that time.

Normally, when predetermined processing on wafer 20 is completed, heat transfer accelerating gas supply valve 202 is closed and heat transfer accelerating gas exhaust valve 204 is then opened so that the gas having been supplied between wafer 20 and stage 10 is exhausted via heat transfer accelerating gas exhaust line 206 to the outside of the processing room. Wafer lift pin 30 is then raised to separate wafer 20 from stage 10.

When sticking occurs, the sticking cancellation processing in S300 of FIG. 3 is carried out.

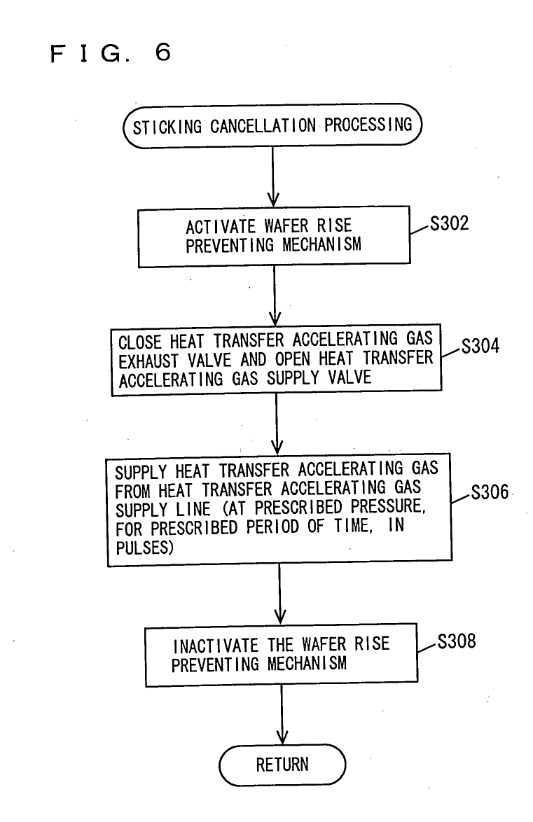

The sticking cancellation processing is now described with reference to FIG. 6.

In S302, control device 100 activates the wafer rise preventing mechanism. In S304, control device 100 closes heat transfer accelerating gas exhaust valve 204 and opens heat transfer accelerating gas supply valve 202.

In S306, control device 100 supplies the heat transfer accelerating gas from heat transfer accelerating gas supply line 200 to a gap between stage 10 and wafer 20 in the processing room. At this time, the gas may be supplied at a prescribed pressure for a prescribed period of time. It may also be supplied in pulses.

In S308, control device 100 inactivates the wafer rise preventing mechanism after confirming that the supply of the heat transfer accelerating gas has been stopped.

An operation of the semiconductor processing apparatus according to the present modification based on the above-described structure and flowchart is now described. The description of the operation of the semiconductor processing apparatus of the present modification is restricted to the operation related to the sticking cancellation processing.

When it is determined that there is sticking, the wafer rise preventing mechanism is activated to prevent wafer 20 from rising due to supply of the heat transfer accelerating gas (S302). While heat transfer accelerating gas exhaust valve 204 is closed, heat transfer accelerating gas supply valve 202 is opened (S304). The heat transfer accelerating gas is supplied from heat transfer accelerating gas supply line 200 at a prescribed pressure for a prescribed period of time (S306).

When the heat transfer accelerating gas such as a helium gas is supplied again as described above, unlike the case where wafer lift pin 30 locally applies a pressure to raise wafer 20, the pressure of the introduced gas is uniformly applied over the entire surface of wafer 20 to raise wafer 20. At this time, wafer 20 has its periphery mechanically held with the wafer rise preventing mechanism or wafer 20 is held with the electrostatic force. Thus, the sticking can be canceled without causing cracking of wafer 20 or wafer displacement due to movement or rise of wafer 20.

When the pressure of the gas supplied to the heat transfer accelerating gas supply line is high, wafer 20 may move on stage 10 or even bounce off stage 10 despite the above-described wafer rise preventing mechanism. As such, the pressure of the heat transfer accelerating gas supplied is set preferably not greater than 1333.22 Pa (=10 Torr), and more preferably not greater than 399.966 Pa (=3 Torr). Although the heat transfer accelerating gas is preferably supplied at a uniform pressure for a prescribed period of time while monitoring the pressure of the heat transfer accelerating gas using pressure sensor 208, the gas supplying method is not limited thereto. The gas pressure may be applied in pulses, or a time during which the gas pressure is applied in pulses and a time during which a uniform pressure is applied may be combined. In doing so, it is possible to prevent wafer 20 from bouncing offstage 10 or moving on stage 10.

Second Modification of First Embodiment

Hereinafter, a second modification of the semiconductor processing apparatus according to the first embodiment of the present invention is described. The semiconductor processing apparatus of the present modification also has a structure for performing the sticking cancellation processing in S300 of FIG. 3.

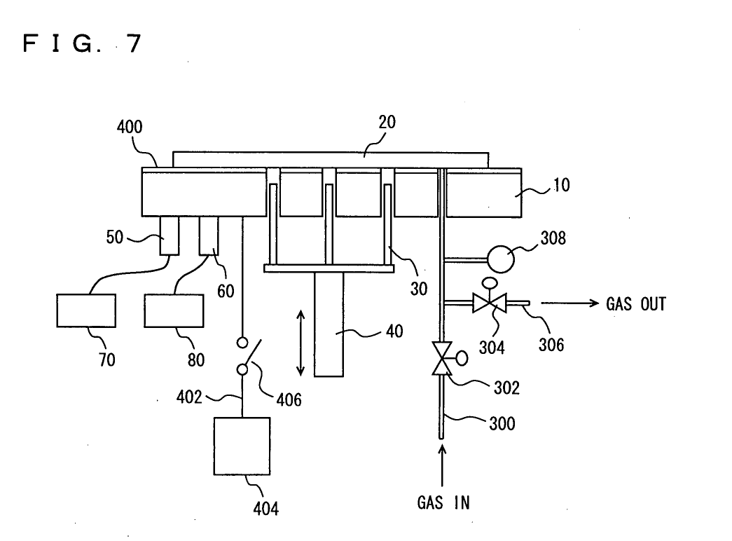

Referring to FIG. 7, a configuration of the semiconductor processing apparatus according to the present modification is described. The semiconductor processing apparatus of the present modification uses plasma for processing the semiconductor wafer. It has a configuration called “electrostatic chuck” where, with an insulating film 400 provided on a surface of stage 10, a direct voltage is applied to stage 10 to electrostatically attract wafer 20 for the purpose of improving adhesion between wafer 20 and stage 10 to accurately control the temperature during the processing of wafer 20.

To achieve the electrostatic chuck, the semiconductor processing apparatus includes a direct-current power supply 404, a cable 402 connected to the direct-current power supply, a switch 406 provided between cable 402 and stage 10, and an insulating film 400 provided on the surface of stage 10. With such a configuration, it is often the case that wafer 20 is in a charged state at the time when plasma is exhausted after completion of processing of wafer 20.

With wafer 20 in the charged state, electric charges cannot be released via the stage surface due to the presence of insulating film 400. In such a case, in the conventional techniques, wafer lift pin 30 is formed, e.g., of a conductive material, or the surface of wafer lift pin 30 is coated with a conductive material, to release the charges accumulated on wafer 20 from the back surface of wafer 20. Wafer 20, however, has various films formed thereon, many of which are insulative films such as a silicon oxide film. Thus, it is difficult to release the residual charges accumulated on the wafer with the conventional techniques.

In the semiconductor processing apparatus according to the present modification, as the sticking cancellation processing, plasma is generated in the processing room to eliminate the charges of wafer 20 via the plasma. To this end, as shown in FIG. 7, the semiconductor processing apparatus of the present modification includes a plasma generating gas supply line 300, a plasma generating gas supply valve 302 provided at plasma generating gas supply line 300, a plasma generating gas exhaust line 306 for exhausting the plasma generating gas to the outside of the processing room, a plasma generating gas exhaust valve 304 provided at plasma generating gas exhaust line 306, and a pressure sensor 308 detecting a pressure of the plasma generating gas. Plasma generating gas supply valve 302, plasma generating gas exhaust valve 304 and pressure sensor 308 are connected to control device 100.

For the plasma generating gas, a gas less affecting wafer 20 by plasma generation is required. In this regard, helium, argon and other rare gases are suitable. Further, with a piping system for supplying gases preinstalled in the processing apparatus, a nitrogen gas having a relatively small effect on the wafer may be employed. Although a gas for generating plasma has been explained in the semiconductor processing apparatus of the present modification, the same gas as the one used for etching or CVD (Chemical Vapor Deposition), or a combination of gases may also be employed.

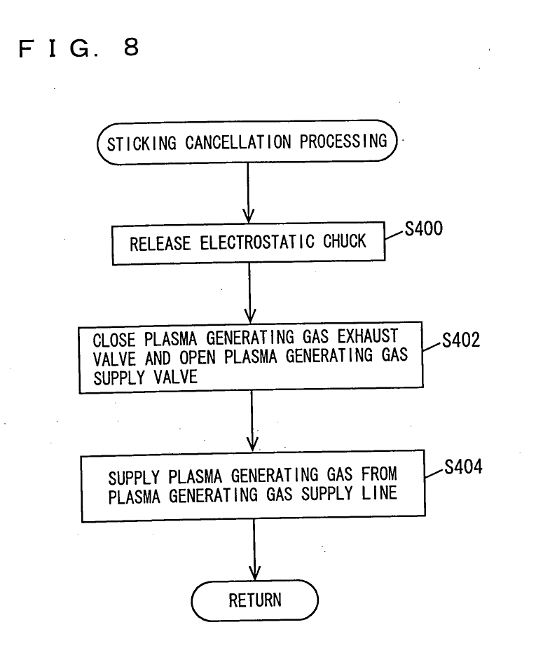

The sticking cancellation processing carried out by control device 100 of the semiconductor processing apparatus according to the present modification is now described with reference to FIG. 8.

In S400, control device 100 releases the electrostatic chuck. At this time, switch 406 is opened. In S402, control device 100 closes plasma generating gas exhaust valve 304 and opens plasma generating gas supply valve 302. In S404, control device 100 supplies the plasma generating gas from plasma generating gas supply line 300 into the processing room.

An operation of the semiconductor processing apparatus according to the present modification based on the above-described structure and flowchart is explained. In the following, only the operation related to the sticking cancellation processing is described.

Upon completion of the predetermined processing using plasma, when it is determined that sticking has occurred, the electrostatic chuck releasing processing is carried out (S400), and plasma generating gas exhaust valve 304 is closed and plasma generating gas supply valve 302 is opened (S402). In this state, the plasma generating gas is supplied from plasma generating gas supply line 300 (S404), and plasma is generated within the processing room.

The plasma thus generated in the processing room can be used to release the residual charges accumulated on wafer 20. Removing the charges from wafer 20 via the plasma can cancel the sticking. Although it has been described that the plasma generating gas is supplied from plasma gas supply line 300 to a gap between stage 10 and wafer 20, the similar effects can be achieved even when the plasma generating gas is supplied from any other place within the processing room.

In the semiconductor processing apparatus according to the present modification, again, the plasma generating gas is supplied to the gap between stage 10 and wafer 20 from plasma generating gas supply line 300. Thus, as in the case of the first modification of the first embodiment described above, wafer 20 may bounce off stage 10 or move on stage 10. To avoid such problems, wafer 20 may be secured with mechanical means or the like during the gas supply, as in the case of the above-described first modification.

As described above, according to the semiconductor processing apparatus of the present modification, when it is determined that there is sticking, the plasma generating gas is used to generate plasma in the processing room to remove the residual charges of the wafer with the plasma, so that the sticking can be cancelled.

The sticking cancellation processing in the semiconductor processing apparatus according to the first modification of the first embodiment may be combined with the sticking cancellation processing according to the present modification. Alternatively, such sticking cancellation processing using a gas may be replaced with sticking cancellation processing using mechanical means, or the processing using the mechanical means and the processing using the gas may be combined as appropriate.

Second Embodiment

Hereinafter, a semiconductor processing apparatus according to a second embodiment of the present invention is described.

The semiconductor processing apparatus according to the present embodiment includes a variable power supply and control unit for a vibrator (hereinafter, “vibrator variable power supply and control unit”) 500, which replaces vibrator power supply and control unit 70 of the semiconductor processing apparatus of the above-described first embodiment.

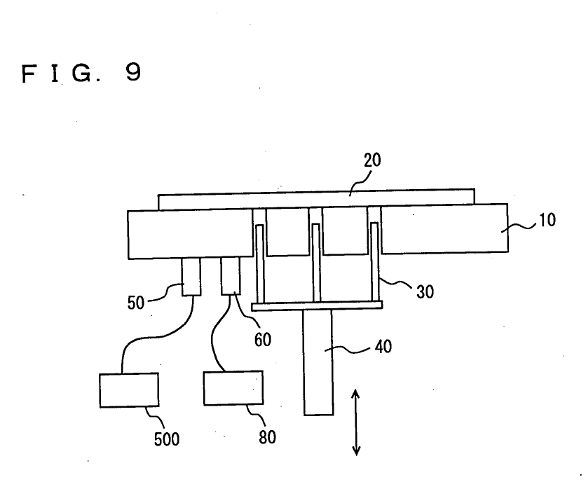

A configuration of the semiconductor processing apparatus of the present embodiment is now described with reference to FIG. 9. As shown in FIG. 9, in the semiconductor processing apparatus according to the present embodiment, vibrator power supply and control unit 70 of the semiconductor processing apparatus shown in FIG. 1 is replaced with the vibrator variable power supply and control unit 500 that makes variable the frequency of the power to be supplied to vibrator 50. Otherwise, the semiconductor processing apparatus of the present embodiment has the configuration similar to that of the semiconductor processing apparatus of the first embodiment, and thus, detailed description thereof will not be repeated here.

Vibrator variable power supply and control unit 500 is a synthesized type power supply using a PLL (phase-locked loop) circuit, having an output frequency in a range from 10 Hz to 100 kHz. When a voltage of an arbitrary frequency fi (Hz) is applied from vibrator variable power supply and control unit 500 to vibrator 50, vibrator 50 generates vibration of frequency fi (Hz), which vibration is applied to stage 10. When the oscillation frequency of vibrator variable power supply and control unit 500 is changed, the frequency of the vibration applied to stage 10 also changes, and sympathetic vibration occurs when the vibration frequency fi (Hz) coincides with a natural frequency of wafer 20.

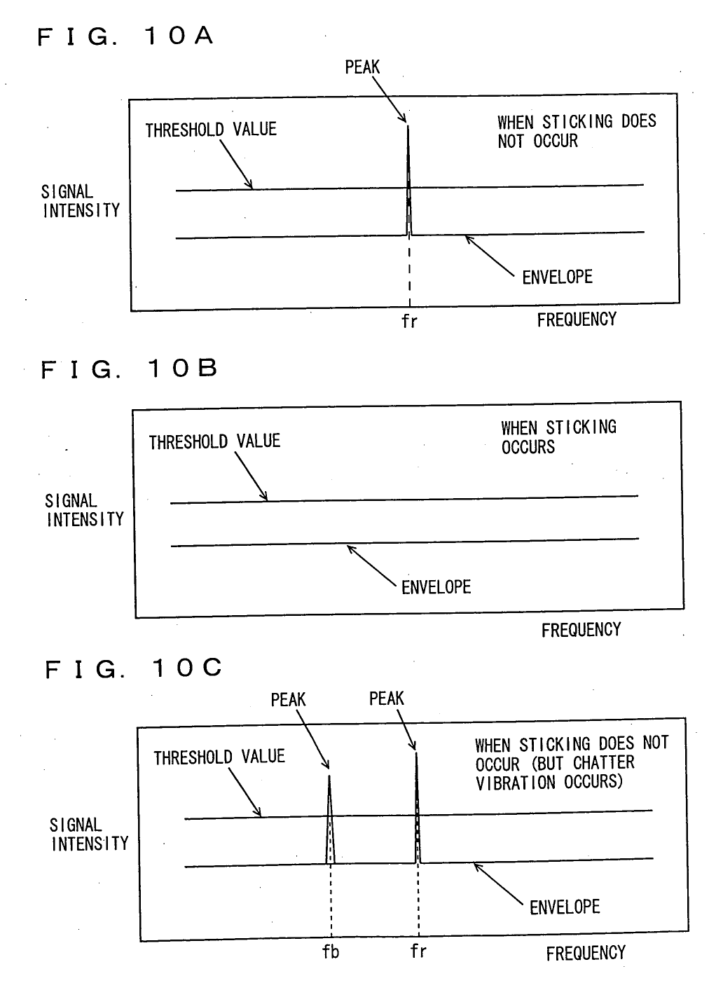

FIGS. 10A-10C each show intensity of a signal received at detector 60 when frequency fi (Hz) applied from vibrator 50 arranged beneath the stage is changed over time. The horizontal axis represents frequency fi (Hz), and the vertical axis represents the signal intensity. FIG. 10A shows the case where there is no sticking. FIG. 10B shows the case where there is sticking. FIG. 10C shows the case where there is no sticking and the “chatter” vibration occurs.

As shown in FIG. 10A, in the absence of sticking, when frequency fi (Hz) applied from vibrator 50 arranged beneath stage 10 is increased over time, for example, sympathetic vibration occurs on wafer 20 when the oscillation frequency becomes frequency fr (Hz) equal to the natural frequency of wafer 20, as described in the first embodiment. Thus, the peak intensity of the signal that is received at detector 60 at this time becomes greater than the envelope of the peak intensity of the signal that is received at detector 60 at the time when there is no sympathetic vibration on wafer 20.

By comparison, as shown in FIG. 10B, in the presence of sticking, stage 10 and wafer 20 are integrated, so that the natural frequency becomes lower than the case of wafer 20 alone. If an appropriate value is selected for the minimum value of frequency fi (Hz) applied by vibrator 50, sympathetic vibration will not occur on the integrated stage 10 and wafer 20 within the sweep band of frequency fz (Hz). As such, by predetermining a threshold value of the intensity of the signal received at detector 60, it is possible to determine that wafer 20 is suffering sticking when there is no signal exceeding the threshold value thus set within the sweep band of frequency fi (Hz).

Further, as shown in FIG. 10C, there is a case where, in the absence of sticking, so-called “chatter” vibration, different from the sympathetic vibration, occurs between stage 10 and wafer 20 in response to vibration received from stage 10. The “chatter” vibration occurs at frequency fb (Hz) as shown in FIG. 10C, with its peak intensity exceeding the threshold value. Although the peak intensity of the “chatter” vibration does not necessarily exceed the threshold value, the “chatter” vibration is accompanied by the sympathetic vibration on wafer 20, and the intensity of the sympathetic vibration exceeds the threshold value. Thus, it can be determined that there is no sticking.

In the present embodiment, there is a case where a peak of the sympathetic vibration exceeding the threshold value is detected, even when sticking has occurred and stage 10 and wafer 20 are integrated, if their natural frequency is greater than the lower limit of the frequency of vibrator variable power supply and control unit 500. Thus, the lower limit of the frequency of vibrator variable power supply and control unit 500 is preferably set to 120 (Hz) taking account of noise due to a commercial power frequency as well, although it depends on a configuration of the semiconductor processing apparatus.

For sweeping the oscillation frequency of vibrator variable power supply and control unit 500, the frequency may be increased or decreased over time, or any special proportionality relation is unnecessary between the time and the frequency. Further, the applied vibration is not limited to the sinusoidal wave, and may have rectangular, triangular or any other arbitrary waveform. Occurrence of sticking may be detected based on a difference in phase of vibration between the waveform of the vibration applied from vibrator 50 to wafer 20 while being swept and the waveform of the vibration detected at detector 60. The sticking may also be detected from a combination of intensity, frequency and phase of the vibration. As such, occurrence of sticking may be detected based on differences in various factors (such as vibration intensity, frequency, phase and others) attributed to the difference between the waveform of the vibration applied while being swept and the waveform of the detected vibration, or the difference between the waveforms of the detected signals.

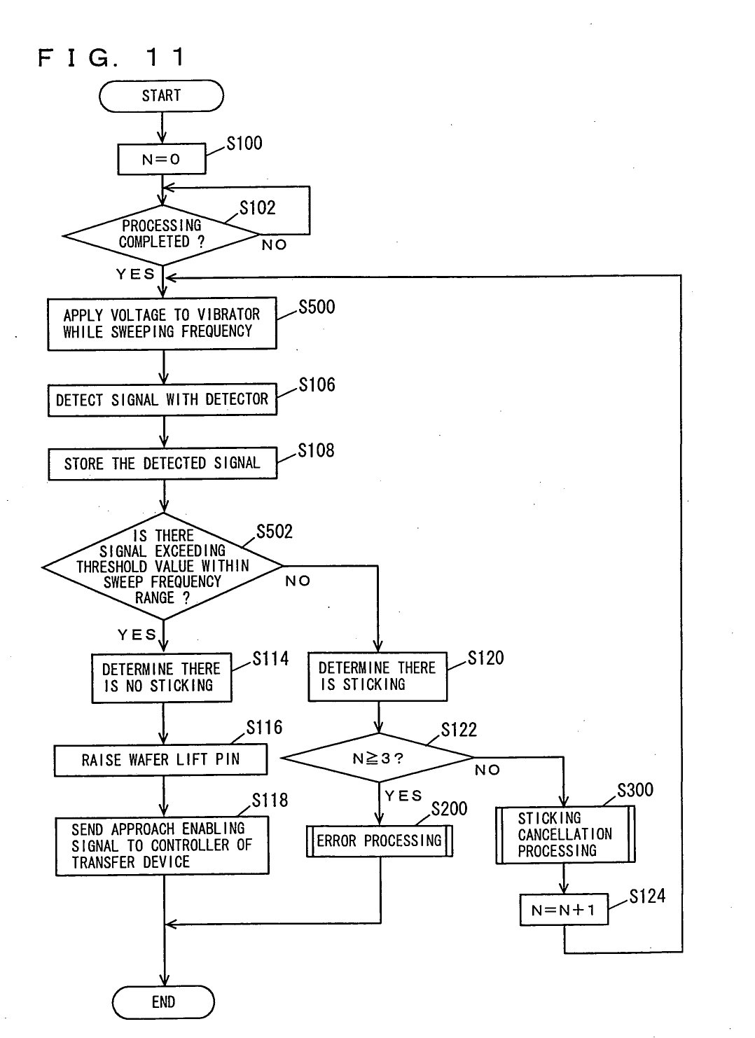

A control structure of a program executed by control device 100 of the semiconductor processing apparatus according to the present embodiment is now described with reference to FIG. 11. In the flowchart of FIG. 11, the same step numbers as those in the flowchart of FIG. 3 indicate the similar process steps, and thus, detailed description thereof will not be repeated here. Although N=3 is indicated, N may be any number of at least 1, as in the case of FIG. 3.

In S500, control device 100 sends a control signal to vibrator variable power supply and control unit 500 to make it apply a voltage to vibrator 50 while sweeping the frequency. In S502, control device 100 determines whether there is a signal exceeding the threshold value within the sweep frequency range. If so (YES in S502), the process goes to S114. If not (NO in S502), the process goes to S120.

An operation of the semiconductor processing apparatus according to the present embodiment based on the above-described structure and flowchart is now described.

Upon completion of the processing in the semiconductor processing apparatus (YES in S102), vibrator variable power supply and control unit 500 applies a voltage to vibrator 50 while sweeping the frequency (S500). A signal detected at detector 60 is stored (S106, S108). When there is a signal exceeding the threshold value within the sweep frequency range (YES in S502), it is determined that there is no sticking (S114). The relation between the frequency and the signal intensity at this time is as shown in FIG. 10A or 10C. In either case, in the absence of sticking, the peak of the signal intensity corresponds to the natural frequency of wafer 20.

When there is no signal exceeding the threshold value within the sweep frequency range (NO in S502), it is determined that there is sticking (S120). The relation between the frequency and the signal intensity at this time is as shown in FIG. 10B.

As described above, according to the semiconductor processing apparatus of the present embodiment, it is readily possible to determine presence/absence of occurrence of sticking without the need of changing the frequency by trial and error, even if the wafer natural frequency, the frequency at which the “chatter” vibration occurs between wafer 20 and stage 10 and others are unknown.

Third Embodiment

Hereinafter, a semiconductor processing apparatus according to a third embodiment of the present invention is described.

While the vibration applied from vibration 50 to stage 10 has a continuous vibration waveform in each of the semiconductor processing apparatuses in the first and second embodiments described above, vibration of an intermittent vibration waveform is applied in the semiconductor processing apparatus of the present embodiment.

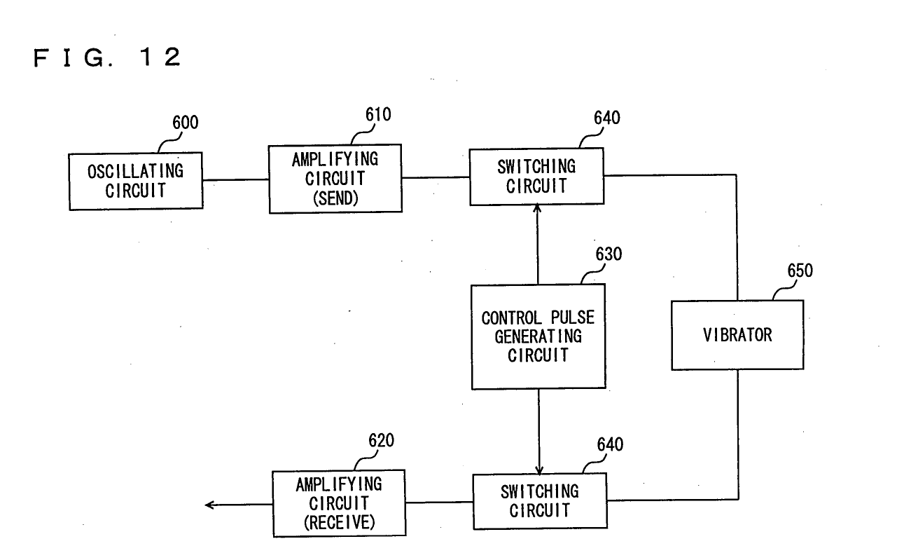

Circuit configurations of a vibration generating unit and a vibration detecting unit of the semiconductor processing apparatus according to the present embodiment are described with reference to FIG. 12. As shown in FIG. 12, the semiconductor processing apparatus of the present embodiment includes an oscillating circuit 600, an amplifying circuit (send) 610 connected to oscillating circuit 600, a switching circuit 640, a vibrator 650, an amplifying circuit (receive) 620, another switching circuit 640, and a control pulse generating circuit 630 controlling switching circuits 640.

Oscillating circuit 600 continuously generates a vibration voltage signal. Amplifying circuit 610 on the sending side drives vibrator 650 to amplify the signal to a level allowing generation of vibration. Switching circuit 640 switches whether or not the generated signal is applied to vibrator 650. That is, it switches vibrator 650 between the sending state and the receiving state. This timing is determined by a pulse from control pulse generating circuit 630, and a signal in exact timing with the pulse is applied to vibrator 650. At the same time, a pulse in opposite timing from that of the sending side is applied to switching circuit 640 on the receiving side, to prevent vibrator 650 from receiving vibration while it is sending vibration.

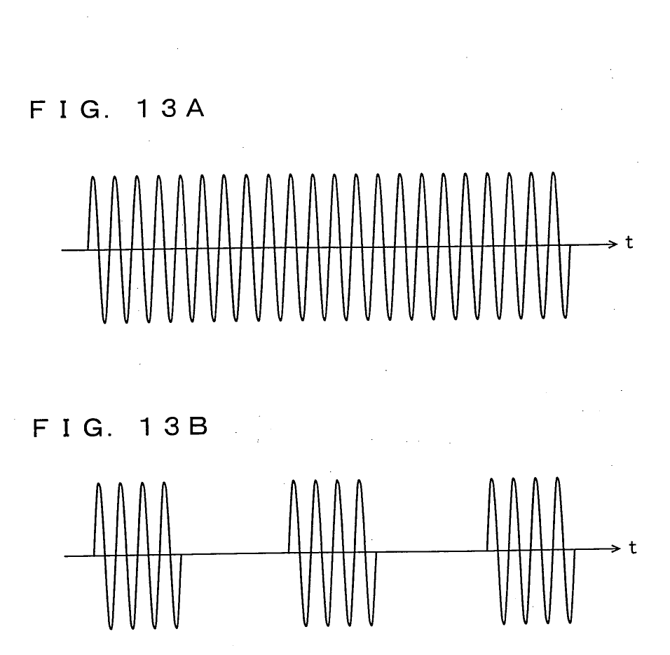

In each of the semiconductor processing apparatuses of the first and second embodiments, the vibration applied from vibrator 50 to stage 10 has a continuous vibration waveform as shown in FIG. 13A. However, when there is no sticking and wafer 20 experiences sympathetic and/or “chatter” vibration with the vibration applied to stage 10, there is a slight possibility, depending on the intensity of the vibration, that the back surface or the edge portion of wafer 20 may contact the surface of stage 10, thereby generating foreign matter. To solve such a problem, in the semiconductor processing apparatus of the present embodiment, vibration is applied intermittently from vibrator 50 to stage 10.

FIG. 13B shows by way of example a waveform of vibration that is applied from vibrator 50 to stage 10 in the semiconductor processing apparatus of the present embodiment. Although the vibration waveform of FIG. 13B has the same frequency as that of FIG. 13A, the intermittent vibration is generated by pausing the oscillation from time to time. Applying the vibration of such a waveform to stage 10 prevents the possibility of generation of foreign matter attributed to movement of wafer 20 on stage 10 or contact of the back surface or the edge portion of wafer 20 with the surface of stage 10 due to the vibration applied to stage 10, without adversely affecting the determination on presence/absence of occurrence of sticking.

In the present embodiment, in addition to application of such intermittent oscillation, the duty ratio is decreased to 50% or less, and a single vibrator is configured to serve also as a detector.

As described above, according to the semiconductor processing apparatus of the present embodiment, the vibrator and the detector can be configured as a single module. Further, the occurrence of foreign matter due to the movement of the wafer on the stage or the contact between the wafer and the stage because of the vibration applied to the stage can be prevented.

The semiconductor processing apparatuses of the first embodiment, the modifications of the first embodiment, and the second and the third embodiments have been described above. The timing of detecting the presence/absence of occurrence of sticking, however, is not limited to the time of completion of disposal of the process gas and the like following completion of the wafer process. For example, it may be detected at an arbitrary time during the wafer process.

Further, in the case of a sputtering device or the like where sticking occurs when a sputtered film covers the wafer end surface and the stage surface, for example, determination of presence/absence of occurrence of sticking may be made at a time during the sputtering, and vibrator 50 may be used to forcibly and externally apply vibration to stage 10 and/or wafer 20 before the wafer end surface and the stage surface are covered with a thick sputtered film, or a gas may be applied to the wafer as described in the first and second modifications of the first embodiment, to further facilitate the cancellation of sticking of the wafer.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A semiconductor processing apparatus, comprising:
a vibration applying unit attached to a wafer mounting electrode and applying vibration to a wafer mounted on said electrode;
a vibration detecting unit attached to the wafer mounting electrode and detecting vibration induced at the wafer mounted on said electrode; and
a determining unit determining presence/absence of sticking of said wafer based on the vibration detected by said vibration detecting unit.

2. The semiconductor processing apparatus according to claim 1, wherein said vibration applying unit applies the vibration to the waver mounted on said electrode while changing a frequency of the vibration over time.

3. The semiconductor processing apparatus according to claim 1, wherein said determining unit determines the presence/absence of the sticking of said wafer based on a waveform of said detected vibration.

4. The semiconductor processing apparatus according to claim 1, wherein said determining unit determines the presence/absence of the sticking of said wafer based on a waveform of the vibration applied by said vibration applying unit and a waveform of said detected vibration.

5. The semiconductor processing apparatus according to claim 1, wherein said determining unit determines the presence/absence of the sticking of said wafer based on a difference between a waveform of the vibration applied by said vibration applying unit and a waveform of said detected vibration.

6. The semiconductor processing apparatus according to claim 1, wherein said determining unit determines the presence/absence of the sticking of said wafer based on a difference in at least one of vibration intensity, frequency and phase between a waveform of the vibration applied by said vibration applying unit and a waveform of said detected vibration.

7. The semiconductor processing apparatus according to claim 1, wherein a frequency of the vibration induced at the wafer mounted on said electrode and detected by said vibration detecting unit is a natural frequency of said wafer.

8. The semiconductor processing apparatus according to claim 1, wherein said vibration applying unit and said vibration detecting unit are configured with a single module.

9. The semiconductor processing apparatus according to claim 1, wherein said vibration applying unit applies pulse vibration to the wafer mounted on said electrode.

10. The semiconductor processing apparatus according to claim 9, wherein the pulse vibration is generated at a duty ratio of no more than 50%.

11. The semiconductor processing apparatus according to claim 1, wherein said vibration applying unit applies the vibration having a frequency of no less than 120 Hz to the wafer mounted on said electrode.

12. The semiconductor processing apparatus according to claim 1, further comprising an output unit outputting an alarm when said determining unit determines that the sticking is present.

13. The semiconductor processing apparatus according to claim 1, further comprising a stop unit stopping the semiconductor processing when said determining unit determines that the sticking is present.

14. The semiconductor processing apparatus according to claim 1, further comprising a communication unit sending sticking information to a host computer when said determining unit determines that the sticking is present.

15. The semiconductor processing apparatus according to claim 1, further comprising a processing unit for cancellation of sticking when said determining unit determines that the sticking is present.

16. The semiconductor processing apparatus according to claim 15, wherein said processing unit includes a mechanical structure for cancellation of said sticking.

17. The semiconductor processing apparatus according to claim 15, wherein said processing unit includes a structure supplying a gas for cancellation of said sticking.

18. The semiconductor processing apparatus according to claim 15, wherein said processing unit includes a structure generating plasma for cancellation of said sticking.

19. The semiconductor processing apparatus according to claim 15, wherein said processing unit includes at least two structures out of
a mechanical structure for cancellation of said sticking,
a structure supplying a gas for cancellation of said sticking, and
a structure generating plasma for cancellation of said sticking.

20. The semiconductor processing apparatus according to claim 16, further comprising a control unit controlling said processing unit to perform sticking cancellation processing for a predetermined number of times.
